(19) United States
(12) Patent Application Publication
(10) Pub. No.: US 2008/0043929 A1
(43) Pub. Date: Feb. 21, 2008

(54) Tie pair configuration test set

(75) Inventor: Chet L. McEvers, Canton, TX (US)

Correspondence Address: GREENBLUM & BERNSTEIN, P.L.C., 1950 ROLAND CLARKE PLACE, RESTON, VA, 20191, US

(73) Assignee: SBC Knowledge Ventures, L.P., Reno, NV (US)

(21) Appl. No.: 11/487,380

(22) Filed: Jul. 17, 2006

(51) Int. Cl. H04M 1/24; H04M 3/08; H04M 3/22

(52) U.S. Cl. 379/22.05

(57) ABSTRACT

A configuration test set is used for testing a configuration of a tie pair. A first line is configured to connect to a first pin-input of a first connector that connects to the tie pair under test. A second line is configured to connect to a second pin-input of the first connector that connects to the tie pair under test. At least one indicator indicates when voltage is applied to the tie pair under test via the first line and applied to the second line via the tie pair under test.

### BACKGROUND

1. Field of the Disclosure

The present disclosure relates to testing tie pairs. More particularly, the present disclosure relates to a configuration test set for testing a high capacity (HiCap) tie pair to determine whether the high capacity tie pair is configured straight or reversed.

2. Background Information

A relay rack in a central office (CO) holds multiple digital signal cross connect (DSX) panels. High capacity 24 gauge copper tie pairs are provided on a DSX panel, which typically has one hundred tie pairs. Each tie pair typically includes five copper wires. When vendors install these tie pairs, they sometimes put them in configured straight and sometimes put them in configured reversed internally. It is often difficult to determine whether tie pairs are configured reversed or straight since the configuration is internal to the tie pair and since each central office may be configured differently.

When a T1 (communications line) circuit needs to be installed or repaired, a technician needs to wire the T1 circuit through a tie pair to get to another relay rack. However, the technician may not know the tie pair internal configuration. Further, relay racks hold multiple DSX panels which may not be numerically aligned on relay racks on opposite sides of the central office, and which each include numerous tie pairs. Accordingly, a technician may not be sure which pins of a particular tie pair on a panel on one side of the central office correspond to pins of the same tie pair on a panel on the other side of the central office.

The technician may be unfamiliar with the internal configuration of a tie pair or with the panel arrangement in a central office. As an example, a tie pair may be installed by the vendor outside the presence of the technician. As another example, a central office may include four panels of tie pairs on each side, with panels numbered 1 and 2 on one side corresponding to panels numbered 3 and 4 on the other side. Accordingly, a technician is easily confused when trying to determine internal configuration of a tie pair or the alignment of a tie pair on different sides of a central office.

Currently, a technician may use a tone generator and finder to test a tie pair. The tone generator is used to generate a tone on one end of a tie pair, and the finder is used to find the other end of the tie pair by searching for the generated tone. However, the tone generated by a tone generator may bleed from one pin to another pin, causing further confusion. Finally, when a technician tests two wires of a tie pair to ensure the two wires are not defective, the technician typically must use loose scrap wire to create a test circuit which includes the two wires of the tie pair to be tested connected at the back of the panels where the wires can be found. However, such loose scrap wire is not always readily available, and time is spent finding and wrapping such loose scrap wire to create the test circuit. Further, male loop plugs available today cannot be used to create such a test circuit because placement of such male loop plugs on the front of a DSX panel will not create a loop that goes through to the back of the DSX panel where the high capacity tie pair wires are found.

As a result of the difficulties described above, T1 communication line circuits may be configured incorrectly, resulting in trouble reports that then take additional efforts to address.

### BRIEF DESCRIPTION OF THE DRAWINGS

FIG. 1 shows an exemplary tie pair in a straight configuration, according to an aspect of the present disclosure;

FIG. 2 shows an exemplary tie pair in a reversed configuration, according to an aspect of the present disclosure;

FIG. 3 shows an exemplary female loop plug and an exemplary tie pair in a straight configuration, according to an aspect of the present disclosure; and

FIG. 4 shows an exemplary female loop plug, an exemplary tie pair in a straight configuration and an exemplary configuration test set, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

According to an aspect of the present disclosure, a configuration test set for testing a configuration of a tie pair includes a first line configured to connect to a first pin-input of a first connector that connects to the tie pair under test. A second line is configured to connect to a second pin-input of the first connector that connects to the tie pair under test. At least one indicator indicates when voltage is applied to the tie pair under test via the first line and applied to the second line via the tie pair under test.

According to another aspect of the present disclosure, the configuration test set includes a third line configured to connect to a third pin-input of the first connector that connects to the tie pair under test.

According to yet another aspect of the present disclosure, the configuration test set includes a first AND gate which includes a first input terminal connected to the first line and a second input terminal connected to the second line. When the tie pair under test is configured straight, voltage from the first line is applied to the first input terminal of the first AND gate and voltage from the second line is applied to the second input terminal of the first AND gate.

According to still another aspect of the present disclosure, the configuration test set includes a second AND gate which includes a first input terminal connected to the first line and a second input terminal connected to the third line. When the tie pair under test is configured reversed, voltage from the first line is applied to the first input terminal of the second AND gate and voltage from the third line is applied to the second input terminal of the second AND gate.

According to another aspect of the present disclosure, the at least one indicator includes a first indicator connected to an output terminal of the first AND gate and indicating when both input terminals of the first AND gate are positively biased. The at least one indicator also includes a second indicator connected to an output terminal of the second AND gate and indicating when both input terminals of the second AND gate are positively biased.

According to yet another aspect of the present disclosure, the configuration test set includes a voltage source which includes a positive terminal and a negative terminal that is grounded, and a resistor connected along the first line between the positive terminal of the voltage source and the first pin-input of the first connector. The first line is configured to connect to the positive terminal of the voltage source.

According to still another aspect of the present disclosure, the configuration test set includes a second resistor connected between the first indicator and the output terminal of the first AND gate.

According to another aspect of the present disclosure, the configuration test set includes a third resistor connected between the second indicator and the output terminal of the second AND gate.

According to yet another aspect of the present disclosure, each of the first indicator and the second indicator is a light emitting diode.

According to still another aspect of the present disclosure, the first connector includes a female connector that receives five pins of the tie pair under test.

According to another aspect of the present disclosure, four pins of the tie pair under test are connected to a female loop plug.

According to yet another aspect of the present disclosure, a first pin input of the female loop plug is connected to a third pin input of the female loop plug.

According to still another aspect of the present disclosure, a second pin input of the female loop plug is connected to a fourth pin input of the female loop plug.

According to another aspect of the present disclosure, when the tie pair under test is configured straight, the first indicator illuminates to indicate that the tie pair under test is configured straight.

According to yet another aspect of the present disclosure, when the tie pair under test is configured reversed, the second indicator illuminates to indicate that the tie pair under test is configured reversed.

According to still another aspect of the present disclosure, when the tie pair under test is configured straight, voltage from the first line is applied to the first pin-input of the female loop plug from a first pin of the tie pair under test, voltage is applied from the first pin-input of the female loop plug to the third pin-input of the female loop plug, and voltage is applied to the second line from the third pin-input of the female loop plug.

According to another aspect of the present disclosure, when the tie pair under test is configured reversed, voltage from the first line is applied to the first pin-input of the female loop plug from a first pin of the tie pair under test, voltage is applied from the first pin-input of the female loop plug to the third pin-input of the female loop plug, and voltage is applied to the third line from the third pin-input of the female loop plug.

According to an aspect of the present disclosure, a method of testing a tie pair configuration includes connecting five pin-inputs of a connector to five pins of a tie pair under test. The connector is connected to a first line, a second line and a third line of a circuit which also includes a first indicator and a second indicator that respectively indicate when the tie pair under test is configured straight and when the tie pair under test is configured reversed. Voltage is applied to the first line of the circuit. The first indicator indicates that the tie pair under test is configured straight when the voltage applied to the first line enters two inputs of a first AND gate from the first line and the second line. The second indicator indicates that the tie pair under test is configured reversed when the voltage applied to the first line enters two inputs of a second AND gate from the first line and the third line.

According to another aspect of the present disclosure, the method also includes connecting four pin-inputs of a female loop plug to four pins of the tie pair under test. The female loop plug is configured such that voltage input to a first pin-input of the female loop plug is output through a third pin-input of the female loop plug. The female loop plug is configured such that voltage input to a second pin-input of the female loop plug is output through a fourth pin-input of the female loop plug.

According to yet another aspect of the present disclosure, when the tie pair under test is configured straight, voltage from the first line is applied to the first pin-input of the female loop plug from a first pin of the tie pair under test and voltage is applied to the second line from the third pin-input of the female loop plug. When the tie pair under test is configured reversed, voltage from the first line is applied to the first pin-input of the female loop plug from a first pin of the tie pair under test and voltage is applied to the third line from the third pin-input of the female loop plug. The tie pair under test is configured straight when the first indicator illuminates. The tie pair under test is configured reversed when the second indicator illuminates.

According to an aspect of the present disclosure, a circuit for testing tie pair configuration includes a voltage source which includes a positive terminal and a negative terminal that is grounded. A first line is configured to connect to a first pin-input of a first connector. A second line is configured to connect to a second pin-input of the first connector. A third line is configured to connect to a third pin-input of the first connector. A first logical gate includes an output terminal, a first input terminal connected to the first line and a second input terminal connected to the second line. A second logical gate includes an output terminal, a first input terminal connected to the first line and a second input terminal connected to the third line. A first indicator is connected to the output terminal of the first logical gate and configured to indicate when both input terminals of the first logical gate are positively biased. A second indicator is connected to the output terminal of the second logical gate and configured to indicate when both input terminals of the second logical gate are positively biased.

The present disclosure enables convenient testing of high capacity tie pairs to determine whether they are configured straight or reversed. The present disclosure provides a configuration test set to place on one end of a tie pair under test. The present disclosure also provides a female loop plug to place on the other end of a tie pair under test. Using the configuration test set, a technician can determine whether the tie pair is straight or reversed. Tie pairs can be conveniently and efficiently tested using the female loop plug and configuration test set pair as described herein.

The configuration test set is configured to indicate the internal configuration of a tie pair. Additionally, the configuration test set can be used to assure the technician that the correct tie pair in a circuit is being tested when the technician is not sure which pins of a particular tie pair on a panel on one side of the central office correspond to pins of the same tie pair on a panel on the other side of the central office.

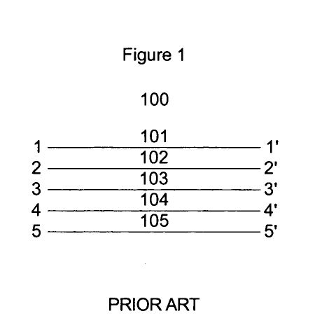

FIG. 1 shows an exemplary tie pair 100 in a straight configuration. As shown, five wires 101-105 each run a straight configuration in the exemplary tie pair shown in FIG. 1. Each wire 101-105 is labeled with a number 1 through 5 at one end and with a number 1′ through 5′ at the other end as shown in FIG. 1. Each end corresponds to a pin. The #1 and #1′ pins (each end of wire 101) are in corresponding positions on each side of the tie pair 100 shown in FIG. 1. Likewise, the #2 and #2′ pins (each end of wire 102), the #3 and #3′ pins (each end of wire 103), the #4 and #4′ pins (each end of wire 104), and the #5 and #5′ pins (each end of wire 105) are in corresponding positions on each side of the tie pair 100 shown in FIG. 1. The exemplary tie pair 100 shown in FIG. 1 may be high capacity 24 gauge copper, such as those provided on a DSX in a central office.

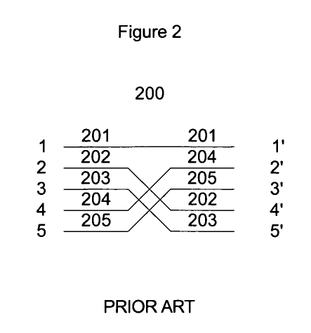

FIG. 2 shows an exemplary tie pair 200 in a reversed configuration. As shown, five wires 201-205 are provided in the exemplary tie pair 200. Each wire 201-205 is labeled with a number 1 through 5 at one end and with a number 1′ through 5′ at another end in FIG. 2. However, only wire #1 is run in a straight configuration, such that the #1 and #1′ pins are in corresponding positions on each side of wire 201 of the tie pair 200. Wires 202-205 are reversed internally, such that wires 202-205 correspond to pins #2, #3, #4 and #5 on one side and pins #4′, #5′, #2′ and #3′ on the other side. In other words, wires 202-205 are reversed internally in the tie pair 200. As in the embodiment of FIG. 1, the exemplary tie pair 200 shown in FIG. 2 may be high capacity 24 gauge copper, such as those provided on a DSX in a central office.

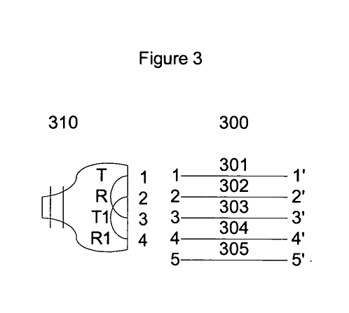

FIG. 3 shows an exemplary female loop plug 310 and an exemplary tie pair 300 in a straight configuration. As shown, the exemplary tie pair 300 includes wires 301 through 305. The female loop plug 310 includes four pin-inputs in a loop configuration. The first pin-input (T) and the third pin-input (T1) are tied together, as are the second pin-input (R) and the fourth pin-input (R1). A fifth pin-input (not shown) may be unnecessary, and description of a fifth pin-input for the female loop plug 310 is omitted herein. The female loop plug 310 provides a loop at the test points for the test board.

The female loop plug 310 may also be used behind a DSX panel for advanced troubleshooting. The female loop plug 310 is used at the rear of a DSX panel where the wires can be found. The female loop plug 310 may be provided to snap on or fit in the configuration test set so the two can stay together, though the female loop plug may also be provided separately.

The four pin-inputs are numbered 1 through 4 and correspond to pins 1-4 on wires 301 through 304 of the exemplary tie pair 300. The female loop plug 310 has two jumpers internally. The first jumper loops pin-input #1 to pin-input #3. The second jumper loops pin-input #2 to pin-input #4. As shown, pin #5 of wire 305 is not used in the configuration shown in FIG. 3. Further, it should be noted that the female loop plug 310 will operate consistently if turned upside down such that pins #1 through #4 are aligned with pin-inputs #4 through #1 instead of pin-inputs #1 through #4, respectively. In other words, pin-inputs #2 and #4 in the female loop plug 310 are not connected or used in the embodiment shown in FIG. 3. However, pin-inputs #2 and #4 are configured to operate the same as pins #3 and #1 respectively if a technician places the female loop plug 310 upside down in comparison to the alignment of pins to pin-inputs shown in FIG. 3.

The exemplary female loop plug 310 shown in FIG. 3 is placed on the end of the exemplary tie pair 300 that includes pins 1 through 5. Thus, if voltage is applied to pin #1 of the exemplary tie pair 300, the voltage is applied to pin-input #1 of female loop plug 310. The voltage loops around to pin-input #3 of female loop plug 310 and to pins #3 and #3′ of wire 303.

In another embodiment, the exemplary tie pair 300 is replaced with the exemplary tie pair 200 in the reversed configuration shown in FIG. 2. Thus, if voltage is applied to pin #1 of the of the exemplary tie pair 200, the voltage is applied to pin-input #1 of female loop plug 310. The voltage loops around to pin-input #3 and pin #3 of wire 203. However, in the embodiment with the exemplary tie pair 200 in the reversed configuration shown in FIG. 2, the voltage that loops to pin #3 of wire 203 is output through pin #5′ as shown in FIG. 2.

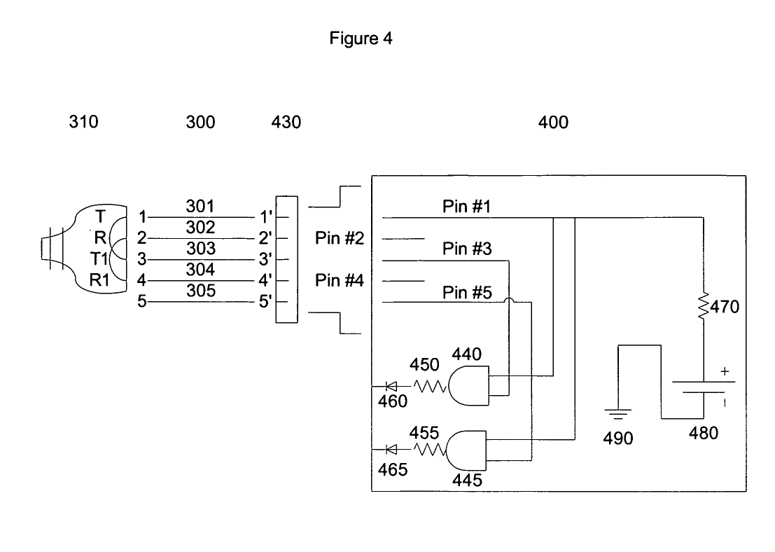

As explained below with respect to FIG. 4, the difference in where voltage is output at pins 1′ through 5′ when the exemplary tie pair 100/300 or 200 is connected to the female loop plug 310 can be exploited. Depending on the pin 1′ through 5′ from which voltage is output, the configuration test set can be used to provide the technician with an indication as to whether the tie pair 100/300 or 200 is configured straight or reversed internally.

FIG. 4 shows the exemplary female loop plug 310, an exemplary tie pair 300 in a straight configuration and an exemplary configuration test set including each of elements 430 through 490. The female loop plug 310 and the exemplary tie pair 300 shown in FIG. 4 are the same as that described in FIG. 3, and detailed description thereof is therefore also omitted.

The configuration test set includes a 5 pin female connector 430 with five female pin-inputs. The five female pin-inputs accept each of corresponding pins 1′ through 5′ of the exemplary tie pair 300. When the exemplary tie pair 300 is configured straight internally, voltage input through pin #1′ is output through pin #3′ when the female loop plug 310 is connected. When the exemplary tie pair 300 is configured reversed internally (e.g., as shown in FIG. 2), voltage input through pin #1′ is output through pin #5′ when the female loop plug 310 is connected.

In an embodiment of the disclosure, circuit 400 includes a battery 480 with a negative terminal connected to ground 490. In an embodiment, the battery 480 is a 9 Volt battery. A resistor 470 is connected to a positive terminal of the battery 480. The resistor 470 is used to break the positive battery voltage of 9 volts down to 5 volts, for example. The voltage that passes through the resistor 470 is input to the terminal 1′ of the wire 421 of the exemplary tie pair 300 via the female pin-input of the female connector 430 corresponding to pin #1′.

A connector from the pin-input of the female connector 430 corresponding to pin #3′ is connected to a first AND gate 440. A connector from the pin-input of the female connector 430 corresponding to pin #1′ is also connected to the first AND gate 440. Accordingly, when the exemplary tie pair 300 is configured straight internally, voltage is provided both to pin #1′ and from pin #3′. Further, the first AND gate 440 will emit a positive voltage when the exemplary tie pair 300 is configured straight internally. The first AND gate 440 outputs voltage to a light emitting diode 460 through a resistor 450.

A connector from the pin-input of the female connector 430 corresponding to pin #5′ is connected to a second AND gate 445. A connector from the pin-input of the female connector 430 corresponding to pin #1′ is also connected to the second AND gate 445. Accordingly, when the exemplary tie pair 300 is configured reversed internally, voltage is provided both to pin #1′ and from pin #5′. Accordingly, the second AND gate 445 will emit a positive voltage when the exemplary tie pair 300 is configured reversed internally. The second AND gate 445 outputs voltage to a light emitting diode 465 through a resistor 455.

Thus, the configuration test set disclosed in the embodiment of FIG. 4 emits light from a light emitting diode 460 when the exemplary tie pair 300 is configured straight internally. The configuration test set disclosed in the embodiment of FIG. 4 emits light from a light emitting diode 465 when the exemplary tie pair 300 is configured reversed internally.

As described above, a technician can place a female loop plug on one end of a vacant tie pair and a configuration test set on the other end. By applying voltage from the battery 480 to the first wire of a tie pair under test, a circuit will be activated and an appropriate light emitting diode will emit light, depending on whether the tie pair is configured straight or reversed.

Although the present specification describes components and functions that may be implemented in particular embodiments with reference to particular standards and protocols, the disclosure is not limited to such standards and protocols. Each of the standards, protocols and languages represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular means, materials and embodiments, the disclosure is not intended to be limited to the particulars disclosed; rather, the disclosure extends to all functionally equivalent structures, methods, and uses such as are within the scope of the appended claims.

What is claimed is:

1. A configuration test set for testing a configuration of a tie pair, comprising:
a first line configured to connect to a first pin-input of a first connector that connects to the tie pair under test;
a second line configured to connect to a second pin-input of the first connector that connects to the tie pair under test; and
at least one indicator that indicates when voltage is applied to the tie pair under test via the first line and applied to the second line via the tie pair under test.

2. The configuration test set of claim 1, further comprising:
a third line configured to connect to a third pin-input of the first connector that connects to the tie pair under test.

3. The configuration test set of claim 2, further comprising:
a first AND gate including a first input terminal connected to the first line and a second input terminal connected to the second line;
wherein, when the tie pair under test is configured straight, voltage from the first line is applied to the first input terminal of the first AND gate and voltage from the second line is applied to the second input terminal of the first AND gate.

4. The configuration test set of claim 3, further comprising:
a second AND gate including a first input terminal connected to the first line and a second input terminal connected to the third line,
wherein, when the tie pair under test is configured reversed, voltage from the first line is applied to the first input terminal of the second AND gate and voltage from the third line is applied to the second input terminal of the second AND gate.

5. The configuration test set of claim 4, the at least one indicator comprising:
a first indicator connected to an output terminal of the first AND gate and indicating when both input terminals of the first AND gate are positively biased; and
a second indicator connected to an output terminal of the second AND gate and indicating when both input terminals of the second AND gate are positively biased.

6. The configuration test set of claim 5, further comprising:
a voltage source including a positive terminal and a negative terminal that is grounded; and
a resistor connected along the first line between the positive terminal of the voltage source and the first pin-input of the first connector,
wherein the first line is configured to connect to the positive terminal of the voltage source.

7. The configuration test set of claim 6, further comprising:
a second resistor connected between the first indicator and the output terminal of the first AND gate.

8. The configuration test set of claim 7, further comprising:
a third resistor connected between the second indicator and the output terminal of the second AND gate.

9. The configuration test set of claim 8,
wherein each of the first indicator and the second indicator is a light emitting diode.

10. The configuration test set of claim 9,
wherein the first connector comprises a female connector that receives five pins of the tie pair under test.

11. The configuration test set of claim 10,
wherein four pins of the tie pair under test are connected to a female loop plug.

12. The configuration test set of claim 11,
wherein a first pin input of the female loop plug is connected to a third pin input of the female loop plug.

13. The configuration test set of claim 12,
wherein a second pin input of the female loop plug is connected to a fourth pin input of the female loop plug.

14. The configuration test set of claim 13,
wherein, when the tie pair under test is configured straight, the first indicator illuminates to indicate that the tie pair under test is configured straight.

15. The configuration test set of claim 14,
wherein, when the tie pair under test is configured reversed, the second indicator illuminates to indicate that the tie pair under test is configured reversed.

16. The configuration test set of claim 15,
wherein, when the tie pair under test is configured straight, voltage from the first line is applied to the first pin-input of the female loop plug from a first pin of the tie pair under test, voltage is applied from the first pin-input of the female loop plug to the third pin-input of the female loop plug, and voltage is applied to the second line from the third pin-input of the female loop plug.

17. The configuration test set of claim 16,
wherein, when the tie pair under test is configured reversed, voltage from the first line is applied to the first pin-input of the female loop plug from a first pin of the tie pair under test, voltage is applied from the first pin-input of the female loop plug to the third pin-input of the female loop plug, and voltage is applied to the third line from the third pin-input of the female loop plug.

18. A method of testing a tie pair configuration, comprising:
connecting five pin-inputs of a connector to five pins of a tie pair under test, the connector being connected to a first line, a second line and a third line of a circuit which also includes a first indicator and a second indicator that respectively indicate when the tie pair under test is configured straight and when the tie pair under test is configured reversed; and
applying voltage to the first line of the circuit,
wherein the first indicator indicates that the tie pair under test is configured straight when the voltage applied to the first line enters two inputs of a first AND gate from the first line and the second line, and
wherein the second indicator indicates that the tie pair under test is configured reversed when the voltage applied to the first line enters two inputs of a second AND gate from the first line and the third line.

19. The method of testing circuit components of claim 18, further comprising:
connecting four pin-inputs of a female loop plug to four pins of the tie pair under test,
wherein the female loop plug is configured such that voltage input to a first pin-input of the female loop plug is output through a third pin-input of the female loop plug, and
wherein the female loop plug is configured such that voltage input to a second pin-input of the female loop plug is output through a fourth pin-input of the female loop plug.

20. The method of testing circuit components of claim 19,
wherein, when the tie pair under test is configured straight, voltage from the first line is applied to the first pin-input of the female loop plug from a first pin of the tie pair under test and voltage is applied to the second line from the third pin-input of the female loop plug,
wherein, when the tie pair under test is configured reversed, voltage from the first line is applied to the first pin-input of the female loop plug from a first pin of the tie pair under test and voltage is applied to the third line from the third pin-input of the female loop plug,
wherein the tie pair under test is configured straight when the first indicator illuminates, and
wherein the tie pair under test is configured reversed when the second indicator illuminates.

21. A circuit for testing tie pair configuration, comprising:
a voltage source including a positive terminal and a negative terminal that is grounded;
a first line configured to connect to a first pin-input of a first connector;
a second line configured to connect to a second pin-input of the first connector;
a third line configured to connect to a third pin-input of the first connector;
a first logical gate including an output terminal, a first input terminal connected to the first line and a second input terminal connected to the second line;
a second logical gate including an output terminal, a first input terminal connected to the first line and a second input terminal connected to the third line;
a first indicator connected to the output terminal of the first logical gate and configured to indicate when both input terminals of the first logical gate are positively biased; and
a second indicator connected to the output terminal of the second logical gate and configured to indicate when both input terminals of the second logical gate are positively biased.
